(19) United States
(12) Patent Application Publication
(10) Pub. No.: US 2018/0163884 A1
(43) Pub. Date: Jun. 14, 2018

(54) SOLENOID VALVE SYSTEM WITH MODULAR BASES

(71) Applicant: METAL WORK S.P.A, Concesio (bs) (IT)

(72) Inventor: Walter BENDOTTI, Brescia (bs) (IT)

(21) Appl. No.: 15/580,941

(22) PCT Filed: Jul. 29, 2016
(86) PCT No.: PCT/IB2016/054575

§ 371 Date: Dec. 8, 2017

(30) Foreign Application Priority Data
Jul. 30, 2015 (IT) 202015000040260

(51) Int. Cl. F16K 27/00; F15B 13/08

(52) U.S. Cl. CPC F16K 27/003; F15B 13/042; F15B 13/0839; F15B 13/0825

(57) ABSTRACT

A solenoid valve system is described which has a solenoid valve and a base operatively connected to the solenoid valve. Each solenoid valve has a compressed air supply conduit, a compressed air delivery conduit, air discharge conduit, air distribution box, configured so as to selectively put in fluid connection the conduits of the solenoid valve, and an electropilot, configured for activating the air distribution box. Each base has a plurality of housings each able to receive a single solenoid valve. Each housing is internally provided with air passage conduits that are put in fluid connection with the conduits of the solenoid valve fixed on the housing. Each base is selected from a group consisting of a base with three housings and a base with four housings.

The present invention relates to a solenoid valve system with modular bases.

As is known, a solenoid valve is a regulating component of a hydraulic or pneumatic circuit which by means of an electric actuator enables opening and closing and, more in general, regulating passage of a fluid inside of the hydraulic or pneumatic circuit. For example, a solenoid valve can be configured for regulating the passage of compressed air between the mouths of a pneumatic circuit so as to be able to command a series of external actuators, if necessary. The actuator of a solenoid valve is usually constituted by a cursor body that under the thrust of an external force of various origin (magnetic, mechanical, piezoelectric, etc.) opens or closes a nozzle.

In certain industrial applications, the assembly is required, on appropriate bases, of two or more solenoid valves to create a so-called solenoid valve island or battery. A solenoid valve island or battery is an assembly of pneumatic solenoid valves typically constituted by:
a certain number of solenoid valves, each of which is internally provided with an air distribution box, with the relative sealing elements, an actuator element generally constituted by a pneumatic piston, configured for moving the air distribution box, and an electropilot, constituted by a coil which, with an electromagnetic force, moves a nucleus that opens and closes the air passage to the piston;
one or more bases, which contain the air passage conduits and the power supply for the electropilots. The bases can be connected in a modular way to one another, with various fixing systems depending on the constructor;
one or more head elements to which the connections for the electrical signals (signals are then sorted at the bases), the pneumatic supply conduits and the centralised compressed air discharge conduits are attached.

Each solenoid valve is fixedly connected to its own base, usually with screws. The design of the solenoid valves and the bases is done in such a way that, when the solenoid valve is fixed to the base, the air conduits and the electrical connections for the electropilots connect automatically.

At present, the market offers various types of bases, which can be summarised as follows:
single bases;
multiple non-modular bases;
modular bases having a plurality of positions.

A single base is configured for housing only one solenoid valve having corresponding dimensions.

Normally, single bases are modular, i.e. connectable to one another.

A multiple base is provided with a number of housings equal to the number of solenoid valves that it is desired to mount. Multiple bases are not modular, which means that it is not possible to connect two or more multiple bases together.

Like a multiple base, also a base having several positions is provided with a number of housings equal to the number of solenoid valves that are to be mounted. Furthermore, multiple bases are modular, i.e. connectable to one another. Today, constructors have a choice between two-position multiple bases and four-position multiple bases.

Consequently, the modularity of the solenoid valve systems is at present enabled using single bases or multiple bases with two and four positions, which can be reciprocally connected to form islands with a variable number of solenoid valves. It is therefore clear that for configurations of odd numbers of solenoid valves, it is necessary to have available all three types of bases, with particular reference to the single bases, which are essential for this type of configuration. Single bases, however, are relatively the most complex type and also the most expensive because, although they are capable of housing only one solenoid valve, they still require the presence of all the components necessary to make the system function, such as electrical connectors, seals for pneumatic sealing of the interface module, etc.

The general aim of the present invention is therefore to provide a solenoid valve system having modular bases that is able to obviate the above-mentioned drawbacks of the prior art in an extremely simple, economical and particularly functional way.

In detail, an aim of the present invention is to provide a solenoid valve system having modular bases in which, with only two base types, it is possible to house an almost unlimited number of solenoid valves.

Another aim of the invention is to provide a solenoid valve system having modular bases in which, with respect to the known systems, the number of components necessary for system to function is reduced.

A further aim of the invention is to provide a solenoid valve system having modular bases in which each base has greater space, compared to known bases, for housing the various components of the system.

These aims, according to the present invention, are attained by providing a solenoid valve system having modular bases as set forth in claim 1.

Further characteristics of the invention are set forth in the dependent claims, which are an integral part of the present description.

In general, the solenoid valve system with modular bases according to the present invention provides for the presence of only two types of bases: with three and four positions. Both types of base are connectable to one another in a modular way for obtaining free and conceptually unlimited compositions. Therefore, the solenoid valve system according to the present invention does not include single bases, nor two-position bases.

The characteristics and advantages of a solenoid valve system with modular bases according to the present invention will be more evident from the following description, given by way of non-limiting example, with reference to the attached schematic drawings, in which:

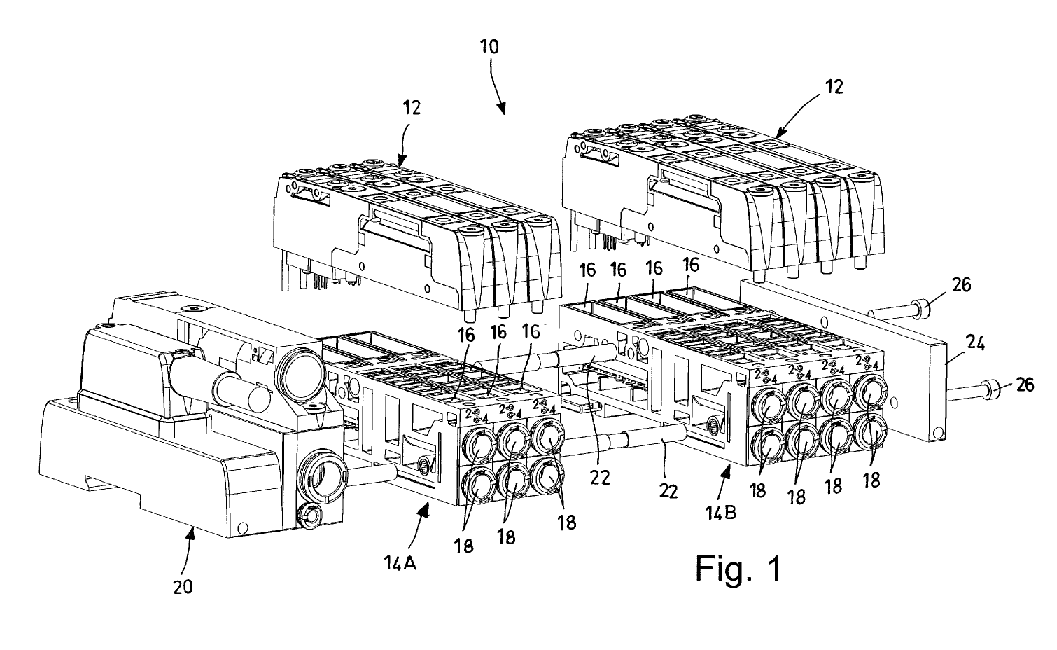

FIG. 1 is a perspective view of an embodiment of the solenoid valve system with modular bases according to the present invention; and

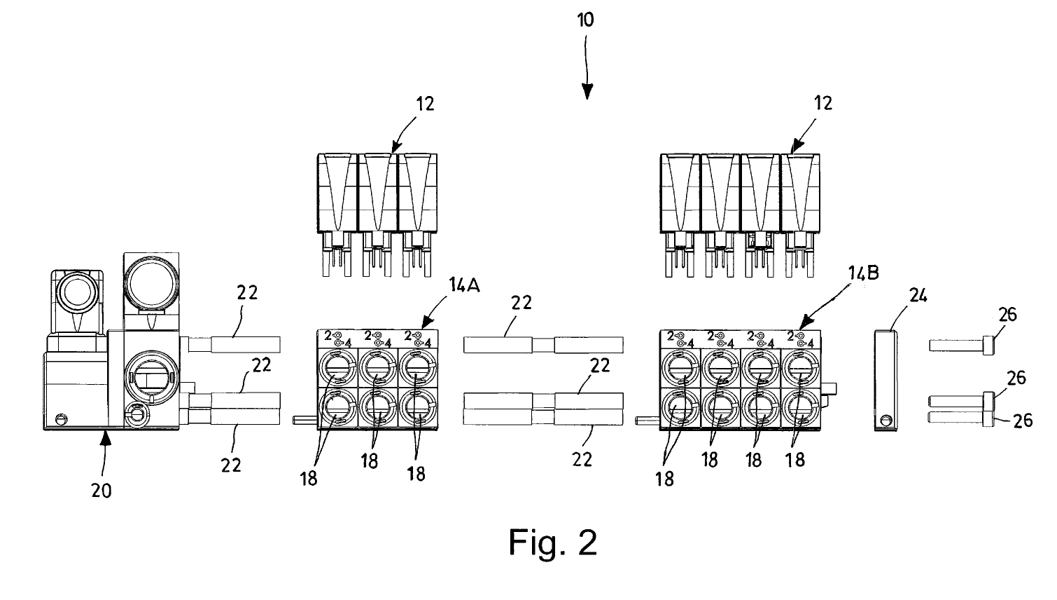

FIG. 2 is a front view of the solenoid valve system with modular bases of FIG. 1.

It is specified that in the attached figures and in the description that follows, numerous components of the solenoid valve system will not be mentioned and/or illustrated, as these are well-known components to a technical expert in the sector.

With reference to the figures, an embodiment of the solenoid valve system with modular bases according to this invention is shown, wholly indicated by reference number 10. The solenoid valve system 10 comprises at least one solenoid valve 12 and at least one base 14A and 14B operatively connected to the at least one solenoid valve 12.

Each solenoid valve 12 is internally provided with at least one compressed air supply conduit, with at least one compressed air delivery conduit for delivering compressed air towards the draw-off points and with at least one return air discharge conduit from discharging the air coming back from the draw-off points. Each solenoid valve 12 is also internally provided with an air distribution box, configured so as to selectively put in fluid connection the compressed air supply conduits, the compressed air delivery conduits and the return air discharge conduits. The air distribution box is preferably constituted by one or more spools, opposite and mobile in alternating motion along the same axis. Lastly, each solenoid valve 12 is also internally provided with at least one electropilot, constituted for example by a coil. The coil, with an electromagnetic force, controls the passage of air in a respective circuit for commanding the movement of the respective distribution box.

Each base 14A and 14B is provided with a plurality of housings or positions 16, each capable of receiving a single solenoid valve 12. Each solenoid valve 12 is designed to be fixed, for example by screws, on the respective housing 16. Each housing 16 is internally provided with air passage conduits that are put in fluid connection with the respective air passage conduits obtained on the solenoid valve 12 fixed on the housing 16. In detail, each housing 16 comprises at least one compressed air supply conduit, at least one compressed air delivery conduit for delivering compressed air towards the draw-off points and at least one return air discharge conduit from discharging the air coming back from the draw-off points. Each housing 16 further comprises at least one outlet mouth 18 for outletting the air, located downstream of the delivery conduits of the base 14A and 14B.

Each base 14A and 14B comprises an electronic board provided with means for electrical connections with the electropilots and configured so as to supply electricity to said electropilots. Each base 14A is designed to be fixed in a modular way to one or more contiguous bases 14B, as well as to an input module 20 which operates as an interface with the hydraulic or pneumatic circuit and receives the command signals for the solenoid valves 12.

In this description, the term “input module” indicates an assembly of electronic circuits and electrical connection interfaces, generally arranged on an electronic board. The input module 20 can be provided with a support body for the above-mentioned electronic boards. In any case, the input module 20 is usually positioned in a predetermined portion of the solenoid valve system 10 and only one input module 20 is provided for the whole solenoid valve system 10.

According to the invention, the solenoid valve system 10 includes only two types of bases 14A and 14B, i.e. at least one base 14A provided with three housings or positions 16 and at least one base 14B provided with four housings or positions 16. Both types of bases 14A and 14B are connectable to one another in a modular way for obtaining free and conceptually unlimited compositions of the solenoid valve system 10.

Both types of bases 14A and 14B are connectable to one another by means of one or more tie rods 22. Each tie rod 22 can be fixed, at a first end thereof, to the input module 20 and, at a second end thereof, to a head element 24 opposite the input module 20. In other words, the input module 20 on one side, which thus operates as a first head element, and the actual head element 24 on the other side are designed to enclose and hold together, by means of the tie rods 22, one or more bases 14A with three housings or positions 16 and/or one or more bases 14B with four housings or positions 16.

Each tie rod 22 is provided with an own fastening screw 26 to the respective head element 20 and/or 24. Each tie rod 22 can have a variable length so as to adapt to the dimensions of both types of bases 14A and 14B. In detail, at least one first tie rod 22, having a length adapted to the width of the base 14A with three housings or positions 16, and at least one second tie rod 22, having a length adapted to the width of the base 14B with four housings or positions 16, are provided.

Thus, the solenoid valve system with modular bases according to the present invention is seen to attain the above-mentioned aims, in particular attaining the following advantages:
the possibility of building islands with any number of solenoid valves. For example:
   1 solenoid valve: 1 three-position base (in which two positions remain unused);
   2 solenoid valves: 1 three-position base (in which one position remains unused);
   3 solenoid valves: 1 three-position base;
   4 solenoid valves: 1 four-position base;
   5 solenoid valves: 2 three-position bases (in which one position remains unused);
   6 solenoid valves: 2 three-position bases;
   7 solenoid valves: 1 four-position base and one three-position base;
   etc.;
reduction of costs with respect to the use of single bases, because the number of components (electrical connectors, seals for the pneumatic sealing of the interface module, etc.) necessary for the functioning of the system is reduced;
each base has an available space that is three or four times greater than the space of the single bases for housing the various components. The larger space translates into both a reduction of costs, as radical miniaturisation can be avoided, and the possibility of housing additional components which improve the performance of the system;
the possibility of building islands with odd numbers of solenoid valves, not provided for in the use of only 2 and 4 position bases.

The solenoid valve system with modular bases thus conceived is susceptible in any case to numerous modifications and variants, all falling within the same innovative concept; furthermore, all the details are replaceable with technically-equivalent elements. In practice, the materials used, as well as the shapes and dimensions, may be any according to technical requirements.

The protective scope of the invention is thus defined by the accompanying claims.

1. A solenoid valve system comprising a solenoid valve and at least one base operatively connected to said solenoid valve, each solenoid valve comprising:
a compressed air supply conduit;
a compressed air delivery conduit;
a air discharge conduit;
a air distribution box, configured for selectively put in fluid connection said conduits of the solenoid valve; and
an electropilot, configured for activating the air distribution box,
each base comprising a plurality of housings each able to receive a single solenoid valve, each housing being internally provided with air passage conduits that are put in fluid connection with said conduits of the solenoid valve fixed on said housing, the solenoid valve system being wherein each base is selected from a group consisting of:
a base having three housings; and
a base having four housings.

2. The solenoid valve system according to claim 1, wherein said bases are connectable to one another by in a modular way with one or more tie rods.

3. The solenoid valve system according to claim 2, wherein each tie rod is fixable, at a first end thereof, to a first head element and, at a second end thereof, to a second head element opposite said first head element, said first head element on the one side and said second head element on the other side being designed for enclosing and holding together, by means of the tie rods, one or more bases with three housings and/or one or more bases with four housings.

4. The solenoid valve system according to claim 3, wherein the first head element is constituted by an input module that operates as an interface with a hydraulic or pneumatic circuit in which the solenoid valve system is inserted, said input module comprising electronic circuits and electrical connection interfaces.

5. The solenoid valve system according to claim 3, each tie rod is provided with a fastening screw that attaches to the respective head element.

6. The solenoid valve system according to claim 2, wherein it comprises a first tie rod, having a length adapted to the width of the base with three housings, and a second tie rod, having a length adapted to the width of the base with four housings.

7. The solenoid valve system according to claim 1, wherein said air passage conduits of each housing comprise a compressed air supply conduit, a compressed air delivery conduit, air discharge conduit and outlet mouth for the air, located downstream of said air discharge conduit of the housing.
